(19) United States
(12) Patent Application Publication
(10) Pub. No.: US 2020/0153760 A1
(43) Pub. Date: May 14, 2020

(54) RESPONSE CENTER

(71) Applicant: Robert PACE, San Diego, CA (US)

(72) Inventor: Robert PACE, San Diego, CA (US)

(73) Assignee: HundredX, Inc., De! Mar, CA (US)

(21) Appl. No.: 16/622,784

(22) PCT Filed: Jun. 13, 2018
(86) PCT No.: PCT/US18/37401

§ 371 Date: Dec. 13, 2019

Related U.S. Application Data
(60) Provisional application No. 62/519,109, filed on Jun. 13, 2017.

(51) Int. Cl. H04L 12/58; G06Q 50/00; G06Q 10/10

(52) U.S. Cl. CPC H04L 51/02; H04L 51/10; G06Q 10/10; H04L 51/32; G06Q 50/01; H04L 51/20

(57) ABSTRACT

A method of communicating a response is disclosed, the method comprising the steps of receiving, at a response center, a message having at least one of a content characteristic and a metadata characteristic, the message associated with an author having an author characteristic; determining a response categorization data based on at least one of the content characteristic, the metadata characteristic, and the author characteristic; determining a first response, the first response associated with the response categorization data; and communicating the first response to the author.

### CROSS-REFERENCE TO RELATED APPLICATION

This application claims the benefit under 35 U.S.C. § 119(e) of U.S. Patent Application No. 62/519,109, filed Jun. 13, 2017, the contents of which are incorporated herein by reference in their entirety for all purposes.

### FIELD OF THE INVENTION

The present invention relates to devices, systems, methods, and computer-readable mediums for generating a response to a message from an author.

### BACKGROUND OF THE INVENTION

As consumers become increasingly mobile and technologically savvy, many increasingly expect to be able to reach out to a business—whether to request information, provide feedback regarding a customer experience, respond to marketing or promotional outreaches, or otherwise engage with the business—and receive a prompt, meaningful response. Tools for near-instant communications, such as email and social media, make it easy for consumers to contact businesses quickly, inexpensively, and with minimal effort. This gives rise to new opportunities for businesses to attract and retain customers, obtain candid feedback, and generally engage with customers and with the public.

For many businesses—particularly those that operate in multiple territories and in multiple languages—the desire to respond to customer comments, and other messages, can quickly overwhelm limited resources for responding to such messages. Many have addressed this challenge by adopting automated tools for providing impersonal, “canned” responses to messages—in some respects, the digital version of the widely despised “form letters” of old.

However, the rise of online communications has not displaced the value of providing a response that feels direct, personal, and meaningful. A business that can provide a response that makes customers feel heard and valued can obtain a competitive advantage over one that leaves customers feeling ignored and disposable. Conventional automated tools can deploy responses quickly, on a large scale, and with limited human resources; but risk backfiring with customers. For example, many automated responses to customer messages can be easily identified by their vagueness; failure to address key details of a customer message; inappropriateness for a particular customer; unawareness of culture or context; and general lack of personality. Customers may react poorly to receiving such messages. In addition, conventional automated responses can fail to capitalize on the potential presented by the ability to respond instantly to customer messages; for example, the potential to present promotional opportunities targeted to the author of the message. However, a more customer-friendly alternative—personal, human-authored responses to many customer messages—is slow, resource-intensive, and not feasibly implemented by many businesses. A solution is needed that can effectively and efficiently provide for review and meaningful response to customer messages, and do so efficiently enough to be practically implemented by organizations with constrained resources.

Further, businesses that engage with customers from different countries or regions may encounter language barriers or cultural barriers that prevent the business from effectively replying to a customer communication. Traditional solutions to overcome these barriers involve either resource-intensive translator work, or computerized translations that lack the nuance of authored messages and can result in mistranslations and misunderstandings.

In addition, with the rise of online video services (including streaming video services), businesses may wish to respond with a tailored video response instead of, or in addition to, a verbal or textual response. Compared with purely verbal or textual responses, video responses present a compelling and social-media-friendly opportunity to engage customers, establish brand awareness, and compete for limited consumer attention. Further, video responses can be easily integrated with other visual forms of customer engagement (e.g., television advertisements, website banner advertisements). Many conventional response tools frequently are designed to respond with verbal messages (e.g., email, traditional mail), but may not scale to video or other multimedia-based forms of response. A solution is needed that can intelligently incorporate video into customer responses.

### SUMMARY OF THE INVENTION

The presently disclosed examples are directed to solving one or more of the problems presented in the prior art, as well as providing additional features that will become readily apparent by reference to the following detailed description when taken in conjunction with the accompanying drawings. In some examples, a response center is configured to receive a message written by an author, the message having at least one of a content characteristic and a metadata characteristic, and the author having an author characteristic. In some examples, the response center is configured to determine a response categorization data based on at least one of the content characteristic, the metadata characteristic, and the author characteristic. The response center may further be configured to generate a response associated with the response categorization data, and communicate the response to the author.

### BRIEF DESCRIPTION OF DRAWINGS

FIG. 1 depicts an example response center according to examples of the disclosure.

FIG. 2 depicts an example message processor according to examples of the disclosure.

FIG. 3 depicts an example message analyzer according to examples of the disclosure.

FIG. 4 depicts an example response generator according to examples of the disclosure.

FIG. 5 depicts an example computer system for implementing an example response center according to examples of the disclosure.

### DETAILED DESCRIPTION

Disclosed herein are devices, systems, methods, and computer-readable mediums for a response center. A response center may be configured to generate a response to a message written by an author based on at least one of a content characteristic of the message, an author characteristic of the author, and a metadata characteristic of the message. A response center may be implemented in any suitable configuration of computer hardware and/or software.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

While the disclosure makes reference to businesses and customers as example users of a response center, the disclosure is not so limited. Users of a response center according to examples of the disclosure could include businesses, customers, employees, networks, organizations, donors, viewers, stakeholders, social media users or groups, or any suitable entity that may wish to convey and/or receive a message. Users may be individuals, or may be any group or combination of the above.

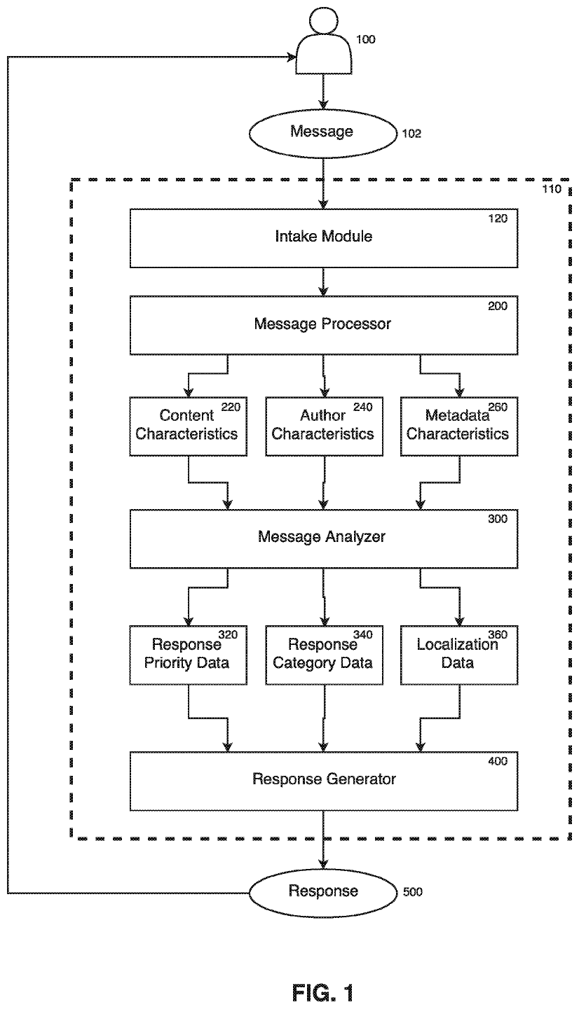

FIG. 1 depicts an example response center 110 according to examples of the disclosure. Response center 110 handles and responds to a message 102 associated with an author 100. In examples in which response center 110 is operated by a business, author 100 may be a current or potential customer of the business. Author 100 may create message 102 in order to communicate with the business. For example, message 102 may reflect the author 100's unsolicited positive or negative feedback regarding the business; a response to a solicitation by the business; a response to promotional offer, video or social media post by the business; a reply to a previous response by the business; or some other communication. Message 102 need not be directed to the business in particular, and need not represent an intent to receive a response; for example, message 102 could be a social media comment directed at nobody in particular. In some examples, response center 110 may be configured to provide unsolicited responses, instead of or in addition to solicited responses.

Message 102 may be communicated to the response center in a number of ways. For example, author 100 may send the message to the response center via email; via an automated form on a website or app; via social media; via text message; via a response to a video or instant message; or via some other form of communication. Message 102 need not be directed communicated to the response center; for example, message 102 may be posted in public on a social media service. Message 102 may be a written message, such as an email message or a social media posting; a selection of binary options or emojis, a verbal message, such as a voice message; an audiovisual message, such as a video or a still image; or may belong to some other format or combination of formats.

In some examples, message 102 may be communicated by viewers of a video using interactive elements embedded in the video. For instance, an interactive prompt may ask a viewer to communicate message 102 (e.g., “Did you understand that?”). Message 102 may then be communicated to response center 110 using any suitable means of communication as described above.

Some response centers may feature an intake module. In example response center 110, message 102 is communicated to intake module 120. Intake module 120 can handle intake and routing of one or more messages, such as message 102. In some examples, intake module 120 can be an email program configured to route and/or process incoming email. In some examples, intake module 120 may seek out messages (e.g., social media posts) to which a response may be generated; for instance, intake module 120 may identify social media posts corresponding to a particular hashtag. In some examples, intake module 120 is responsible for preprocessing of messages, such as by converting messages of varying formats into a consistent data format for later processing. In some examples, intake module is responsible for routing message 102 to an appropriate destination for handling. For example, a message 102 that is addressed to or should be handled by a specific department or point of contact may be routed to that department or point of contact. In some examples, such as example response center 110, intake module 120 routes all messages to the same destination.

In some examples, intake module 120 may accumulate a plurality of messages, such as message 102, and aggregate them so that response center 110 can provide a mass response, or one or more clusters of different responses, to the plurality of messages. The plurality of messages need not all be of the same time; for example, the plurality could include a combination of email messages, voice mail messages, SMS messages, and social media posts.

In example response center 110, message 102 may be presented to message processor 200. Message processor 200 can extract information from message 102. For example, message processor 200 may extract one or more content characteristics 220; one or more author characteristics 240; and/or one or metadata characteristics 260.

Content characteristics 220 may include information, such as semantic information, relating to an aspect of the content of message 102. For example, a content characteristic 220 may identify a purpose of message 102—for instance, that message 102 conveys feedback relating to a product or service; includes a request for information; or is a response to a particular communication (such as an advertisement or promotion). Content characteristics 220 may also identify more specific information. For example, if message 102 conveys feedback relating to a product or service, content characteristics 220 may, for instance, identify the product or service in question (e.g., widget model number B1445); describe the nature of the feedback (e.g., complaint regarding battery life); or identify specific comments relating to the product or service. If message 102 includes a request for information, content characteristics 220 may, for instance, identify the information requested (e.g., product release dates, lists of distributors); the date by which it is requested (e.g., by tomorrow; within 90 days); or the type of response desired (e.g., an email; a printed document; a link to an online video). If message 102 is a response to a particular communication, content characteristics 220 may, for instance, identify the communication to which message 102 responds (e.g., a television advertisement; an email); or identify the nature of the response (e.g., general enthusiasm about an advertisement; interest in purchasing an advertised product). In some examples, content characteristics 220 can include opinion data, such as an opinion conveyed by message 102 (e.g., a particular product is unsatisfactory; a particular football team's performance this season is inadequate). In some examples, content characteristics 220 can include emotional data, such as an emotion motivating the author to write message 102 (e.g., message 102 expresses anger, approval, or jealousy toward a particular football team). Content characteristic 220 may further identify the language (e.g., English, Chinese, French) of message 102. Content characteristics 220 are not limited to any particular type of message, type of content, or type of information. Other information that may be indicated by content characteristics 220 will be apparent.

Author characteristics 240 may include information, such as identifying information, relating to the author 100 of message 102. For example, author characteristics 240 may include the author's name; location; contact information; history of transacting with a business (e.g., product purchase history); interests; purchasing habits; preferred language; or demographic information (e.g., age, gender). Author characteristics 240 may be characterized as a “profile” of author 100. Such a profile may comprise characteristics pertaining to author 100. For example, a profile of author 100 could include author 100's history of social media communication; demographic information (e.g., age, location); and perceived interests. In some examples, author characteristics may be derived from message 102. In some examples, author characteristics 240 may be determined using information external to message 102, such as information in an external database (e.g., a database including customer information for a business); information retrieved from an internet search (e.g., via Google) or a public records search (e.g., via LexisNexis); or information gathered from social media (e.g., an author's Facebook activity history; YouTube user name; or number of Twitter followers). In some examples, author characteristics 240 may include custom marketing information, such as information identifying a type of customer group that the author may belong to. For example, an author of a message to a university might be identified by author characteristics 240 as a parent of a student at the university; a fan of the university's football team; or a prospective student. An author may further be identified by author characteristics 240 as belonging to two or more such groups (e.g., prospective student and football fan). In some examples, author characteristics 240 may quantify an author's relationship with one or more groups; for instance, an author may be categorized as 60% prospective student and 40% football fan, reflecting that the author identifies to a stronger degree as a prospective student than as a football fan. In some examples, author characteristics 240 may identify a probability that an author belongs to a group; for instance, author characteristics 240 may identify a 75% chance that an author is a parent of a student, and a 25% chance that the author is a football fan. In some cases, an author may be a group (e.g., an organization, a corporation, or a social media group), and author characteristics 240 may describe characteristics (e.g., membership, demographics) of that group. Author characteristics 240 are not limited to any particular type of author or type of information. Other information that may be indicated by author characteristics 240 will be apparent.

Metadata characteristics 260 may include information, such as technical information, bibliographic information, or metadata, relating to message 102. For example, if message 102 is an email, metadata characteristics 260 may include information included in an email header, such as the date and time the email was sent; the sender's email address; or addressing information. Metadata characteristics 260 might further identify whether and when the author has previously communicated with example response center 110. In some examples, metadata characteristics 260 may include information relating to the communication of message 102 to response center 110. For instance, metadata characteristics 260 may indicate whether message 102 was communicated via a web form or app, via social media, via text message; via a response attached to a video, or via some other means of communication. In some examples, metadata characteristics 260 may further indicate a device used by the user to communicate message 102 (e.g., a specific type of smartphone; a tablet; a PC). In some examples, metadata characteristics 260 may be derived from information associated with message 102; for example, metadata 260 may include a physical location derived from an IP address associated with message 102. In some examples, metadata characteristics 260 can include whether the author of message 102 is soliciting a response. Metadata characteristics 260 are not limited to any particular type of metadata or type of information. Other information that may be indicated by metadata characteristics 260 will be apparent.

With reference to FIG. 1, example response center 110 may include message analyzer 300. Message analyzer 300 may analyze message 102—for example, via content characteristics 220, author characteristics 240, and/or metadata characteristics 260—and output one or more data that are relevant to responding to message 102. For example, message analyzer 300 may output response priority data 320, which may indicate a priority of responding to message 102; response categorization data 340, which may be used to generate and/or select a response to message 102; and/or localization data 360.

Response priority data 320 may indicate information relating to how a response center may wish to prioritize responding to message 102. For example, priority data 320 may indicate that responding to message 102 should be considered high priority relative to responding to other messages. Priority data 320 may be based on one or more of content characteristics 220, author characteristics 240, and/or metadata characteristics 260. For instance, author characteristics 240 indicating that author 100 is a particularly important or influential customer (e.g., a customer with a large number of followers on social media) may result in priority data 320 indicating that responding to message 102 is high priority. As another example, metadata characteristics 260 and/or content characteristics 220 indicating that the same author has already written three messages about the same issue may make responding to message 102 high priority. Likewise, content characteristics identifying message 102 as relating to a particularly sensitive issue (e.g., threatened legal action) may make responding to message 102 high priority. Conversely, other characteristics may result in priority data 320 indicating that responding to message 102 is low priority. For example, if content characteristics 220, author characteristics 240, and/or metadata characteristics 260 indicate that author 100 is not a current customer and is unlikely to ever become a customer, then responding to message 102 may be considered low priority. In some examples, response priority data 320 may indicate that author 100 should receive a human-authored response, rather than a computer-generated response, if possible.

Response categorization data 340 may include data for generating a response 500 to message 102. For example, response categorization data 340 may indicate elements that should be included in response 500. Response 500 may then be generated according to response categorization data 340 as described below. Response categorization data 340 may be based on one or more of content characteristics 220, author characteristics 240, and/or metadata characteristics 260. For instance, in an example in which message 102 is sent to a university, if author characteristics 240 indicate that author 100 is an alumnus of the university, response categorization data 340 may indicate that response 500 should acknowledge that author 100 is an alumnus. As another example, if content characteristics 220 indicate that message 102 relates to the university's football team, response category 340 may indicate that response 500 should reference the football team. As another example, if metadata characteristics 260 indicate that author 100 composed message 102 on a smartphone, response categorization data 340 may indicate that response 500 should suggest that author 100 download an app available to smartphone users.

In some examples, response categorization data 340 may include data relating to the type or format of response 500 that should be generated and/or selected. In some examples, response categorization data 340 may indicate that response 500 should be a video response, such as an internet link to an online video. In some examples, response categorization data 340 may indicate that response 500 should be a text-based response, such as an email, a text message, or a social media post. These response types may be non-exclusive; for example, response 500 may include both a text component and a video component.

In some examples, response categorization data 340 may relate to one or more clusters of responses. For example, a cluster of responses might encompass a group of responses that relate to a single theme (e.g., informing football fans of an upcoming ticket presale). An author 100 may receive a response 500 that corresponds to a cluster of responses. Response categorization data 340 may indicate which cluster a response 500 should belong to; for example, if content characteristics 220 indicate that message 102 relates to football, and author characteristics 240 indicate that author 100 is a football fan, then response categorization data 340 may indicate that response 500 should be belong to a cluster of responses intended for football fans. In some examples, responses within a cluster may be personalized for a recipient (e.g., by substituting the name of each individual recipient).

In some examples, localization data 360 may include language or territory information, which may be used to generate a response 500 tailored to that language or territory. For example, if message 102 was written in Spanish, localization data 360 may indicate that a Spanish-language response 500 should be used. In some examples, response 500 may be translated from a first language to the language of message 102. In some examples, response 500 may be a response specifically authored for speakers of the language of message 102 or for authors in the author's territory. This can help avoid, for example, cultural misunderstandings that can arise from mistranslations or from territory-specific language. Localization data 360 can further include information related to specific dialects within a single language, or information related to local preferences.

With respect to FIG. 1, response center 110 may include response generator 400. Response generator 400 may output a response 500 according to data from message analyzer 300, such as response priority data 320, response categorization data 340, and/or localization data 360. In some examples, response generator 400 may output a response 500 according to data from message processor 200, from message 102 itself, or from some other source. In some examples, response generator 400 may select a prewritten response 500, for example from a database of such responses. In some examples, response generator 400 may select a base response, for example from a database of such responses, and generate response 500 by customizing the base response with additional information. For instance, response generator 400 may generate response 500 by inserting the name of author 100 into a base response that is not directed to any particular recipient. In some examples, response generator 400 may interface with a human response team that can generate response 500.

In some examples, response generator 400 may determine a response 500 based on programmed decision rules. Such rules may be based, for example, on an aspect of author 100 or message 102 (e.g., an author's mood or intensity). Such rules can prioritize certain criteria when generating a response. For example, if an author 100 indicates that he enjoyed his vacation until he was severely injured by an employee, response generator 400 could identify the author's injury as being more significant than his enjoyment of the vacation, based on a programmed response hierarchy, when determining a response 500.

In some examples, as described further below, response generator 400 may output a response 500 according to data relating to past responses generated, selected, and/or communicated by response center 110. For example, if a previous response to author 100 did not produce the intended reaction by author 100, response generator 400 may use that knowledge to select a different response. Similarly, response generator 400 may utilize data that relates response types to whether or not those response types produced the desired reaction, and generate and/or select response 500 based on that data.

With respect to FIG. 1, response 500, after being generated and/or selected by response generator 400, may be communicated to author 100. This communication may occur through any of a variety of communication methods, such as email, telephone, text message, in-app response, traditional mail, or social media.

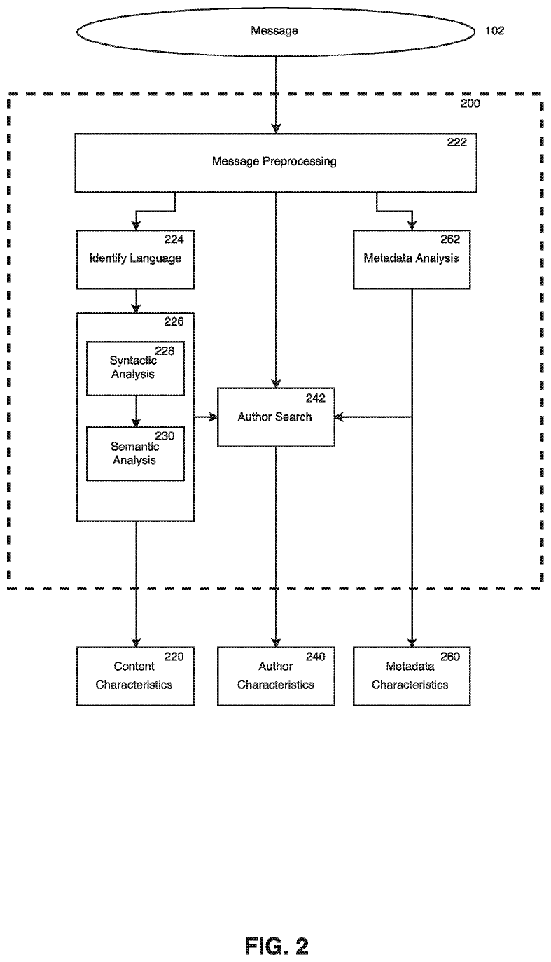

FIG. 2 illustrates an example message processor 200, which may process message 102 and output one or more content characteristics 220, author characteristics 240, and/or metadata characteristics 260. In some examples, at stage 222, message processor 200 may engage in preprocessing of message 102 to put message 102 into a format that can be further processed by message processor 200. For example, if message 102 is a hand-written message, preprocessing 222 may include an optical character recognition module or a handwriting analysis module to express the hand-written text as computer-readable text. As another example, if message 102 is a voice message, preprocessing 222 may include a speech-to-text module to express the voice message as computer-readable text.

In some examples, at stage 224, message processor 200 may identify the language (e.g., English, Chinese, French) of message 102. The language of message 102 may be used (e.g., reflected in localization data 360 with respect to FIG. 1) to determine how message 102 is processed (e.g., by message processor 200); to determine how message 102 is analyzed (e.g., by message analyzer 300); and/or to determine how a response 500 is generated and/or selected (e.g., by response generator 400). The language may further be used to determine to whom at the organization the message should be addressed if human intervention is desired.

In some examples, message processor 200 may include a language processing module 226 to engage in language processing, for example in accordance with the language of message 102, to identify one or more content characteristics 220 that relate to the content of message 102. Language processing module 226 may include one or more stages. In some examples, language processing module 226 may include a syntactic analysis stage 228 that identifies the syntactic structure, or other syntactic information, of message 102. For instance, syntactic information could identify individual sentences, subjects, verbs, and other grammatical elements of message 102, which grammatical elements may be further processed by language processing module 226. In some examples, language processing module 226 may include a semantic analysis stage 230 that identifies semantic information, such as meaning and context, associated with message 102. For instance, semantic information could include that the subject of message 102 is a television advertisement that aired during the 2016 Olympics. As another example, semantic information could include that message 102 expresses a negative sentiment about a subject. As another example, semantic information could include that message 102 identifies a particular entity, such as the CEO of a particular company. Such semantic information may be reflected as one or more content characteristics 220.

In some examples, message processor 200 may include a metadata analysis module 262. Metadata analysis module 262 can engage in metadata analysis of message 102 to identify one or more metadata characteristics 260 that relate to message 102. In some examples in which message 102 is an electronic message transmitted via a network, metadata analysis 262 may include analysis of networking information or addressing information of message 102, for instance to identify a device or location associated with message 102 (e.g., by performing a reverse lookup of an IP address associated with message 102). In some examples, metadata analysis module 262 may compare message 102 against a database of previous messages, for instance to compile statistical information relating message 102 to previous messages (e.g., whether an internet domain associated with message 102 sends a disproportionately large number of messages). Metadata characteristics 260 may incorporate or reflect this information. In some examples, metadata characteristics 260 may include a date and time at which message 102 was authored or communicated to response center 110. In some examples, metadata characteristics 260 may include information provided by a device identifier. For instance, an identifier associated with a tablet device could identify a specific location (e.g., a luxury suite at a sports venue) and/or identity (e.g., a high value season ticket holder) associated with message 102 and/or author 100. Similarly, in some examples, metadata analysis module may use GPS data associated with an author 100, a message 102, or a device to identify a location and/or identity.

The outputs of language processing module 226 and/or metadata analysis module 262 may be used to identify one or more author characteristics 240 that relate to the author 100 of message 102. In some examples, the outputs of language processing module 226 and/or metadata analysis module 262 may include identifying information for author 100, such as the author's name, email address, or IP address. Author characteristics 240 may reflect this identifying information. In some examples, the identifying information may be input to an author search 242, which may output one or more author characteristics 240. Author search 242 may include a search of public records; social media; customer databases; or other sources to identify author characteristics 240. In some examples, author characteristics 240 may reflect contributions that author 100 has made to social media sites. In some examples, author characteristics 240 may reflect biographical information or demographic information relating to author 100.

In some examples, author characteristics 240 can be determined based on direct input data. For example, author 100 could be presented with an opportunity to provide direct input; this direct input could comprise a feedback prompt; a survey (e.g., a brief online survey) comprising questions to which author 100 is invited to provide answers; an opportunity to provide unsolicited comments; and/or other suitable invitations to provide input. In some examples, questions presented to author 100 may belong to a list of questions presented to all authors. In some examples, the questions presented may be selected from a list, or synthesized, based on information related to message 102, or based on information known about author 100. For example, if message 102 relates to a football team's current performance, author 100 may be presented with an invitation to provide direct input related to the football team (e.g., survey questions regarding how long author 100 has been a fan of the football team, or how frequently author 100 attends football games; an open-ended prompt asking what author 100 loves about the football team; or a comment box to provide any thoughts at all about the football team). Author 100 may be prompted for a numerical response (e.g., rate your level of interest from one to ten); a free-text response (e.g., describe your level of familiarity with this product); a selection of preexisting responses (e.g., which of the following best describes you); or some other type of response (e.g., an emoji or another non-textual response). Similarly, author 100 may provide a response in any suitable format—for example, text, emojis, gestures, video content, audio content, or any suitable combination. The direct input provided by author 100 can be used to refine author characteristics 240; for instance, if author 100 responds that his or her level of interest in a certain football team is a ten on a scale of one to ten, author characteristics 240 can reflect that author 100 is a big fan of that football team. In some examples, direct input provided by author 100 may be further marked or categorized (e.g., a numerical response from one to ten may be classified as “good” or “not good”).

In some examples, author 100 need not respond to all invitations for direct input. For example, author 100 could be presented with a ten-question survey, and could be instructed to only answer those questions that author 100 most cares about. Similarly, author 100 could be instructed that the entire survey is optional. Information about which survey questions author 100 chooses not to answer, or whether author 100 response to invitations to provide input at all, can be used to refine author characteristics 240. For instance, if author 100 chooses to answer survey questions about a university's football team, but chooses not to answer survey questions about the university's global impact, author characteristics 240 can reflect that author 100 is interested in football, and that author 100 may not be interested in global impact. This information can be used to create a tailored profile of author 100 that notes the author's likes and dislikes, for example, which can be used as described below to create a more tailored and effective response to author 100 than may be possible otherwise. Further, identifying information that is of little interest to author 100 can improve computational efficiency by narrowing the pool of potential responses that may be searched, processed, and/or presented to author 100.

In some examples, author 100 may be prompted for direct input based on information already known about author 100, or based on direct input previously provided by author 100 (including non-responses to invitations to provide input, such as described above). For instance, if author 100 chooses to provide direct input about the university's football team and the university's global impact, but chooses not to provide direct input about the university's alumni network, author 100 can receive future prompts directed to the football team and/or global impact. These prompts may be directed to increasingly specific or nuanced information; for instance, an author 100 who has indicated an interest in the football team's coaching staff might receive specific coaching staff-related prompts (e.g., “what do you think of the defensive coordinator's play-calling strategy?”) that might be irrelevant to most authors. In this way, author 100 is able to drive the prompts for direct input, and in response, receive prompts that are more relevant to author 100, or that are more likely to yield new and useful information about author 100. This information can in turn be used to refine general, broad responses into more specific and meaningful responses that incorporate author 100's specific likes, dislikes, preferences, and other known characteristics, such as described below. And as described above, identification of specific responses can allow for more efficient use of computing resources, particularly at large scales, by pruning the universe of potential responses that must be searched or processed.

In some examples, such as where author 100 provides direct input via an online survey, metadata can be collected about the manner in which author 100 provides direct input. For instance, it can be determined how much time author 100 spends on any individual survey question; if author 100 spends more time on question 1 than on question 2, that may indicate that author 100 had more difficulty arriving at an answer for question 1 than for question 2. In some examples, this can indicate a higher level of interest in question 1 than in question 2. In some examples, it can indicate a high level of confidence in answering question 2. This data can be used to further refine author characteristics 240. Similarly, the frequency with which an author 100 provides direct input on a subject (e.g., via an open-ended feedback prompt), or the volume of such direct input, can indicate author 100's level of enthusiasm for that subject.

In some examples, author characteristics 240 can be determined based on information from a combination of multiple sources, having different types of media. For example, author characteristics 240 can be based on author 100's responses to survey questions (i.e., survey media type), in combination with author 100's social media posting history (i.e., social media type). For instance, author 100 might respond to a survey indicating that he is interested in tickets for a certain football team; and may have a history of commenting on social media about that football team's record against its division rival. Combined, this information can indicate that author 100 might be particular interested in tickets for the football team against its division rival. Other types of media could include email; conventional mail; voice; SMS messaging; instant messaging; or any other suitable type.

In examples, where author 100 is a group, author characteristics 240 can include characteristics of the group, instead of or in addition to characteristics of its individual members. For example, if author 100 is a social media group consisting of football fans from the American South, author characteristics 240 can include the group's general geographic location (the American South), and the group's defining interest (football).

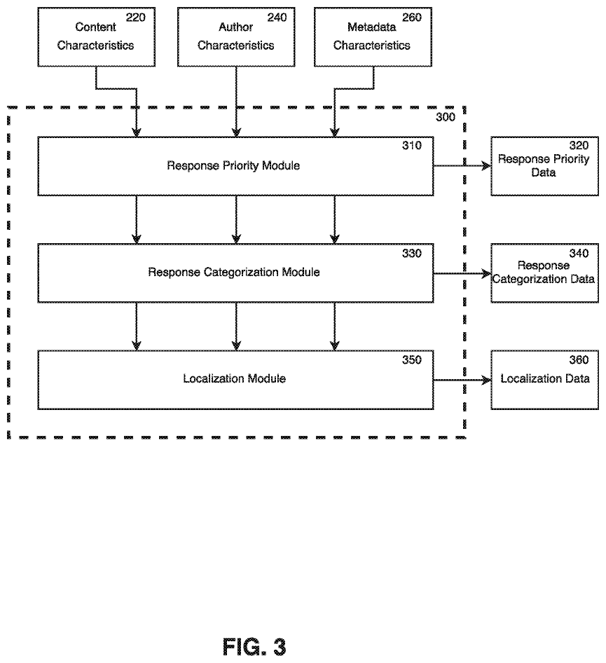

FIG. 3 illustrates an example message analyzer 300. In some examples, message analyzer 300 inputs one or more content characteristics 220, author characteristics 240, and/or metadata characteristics 260 relating to message 102, and outputs one or more of response priority data 320, response categorization data 340, and/or localization data 360.

With respect to FIG. 3, in some examples, message analyzer 300 includes a response priority module 310. Response priority module 310 can accept as input one or more content characteristics 220, author characteristics 240, and/or metadata characteristics 260 relating to message 102. Response priority module 310 can output response priority data 320 that indicates a priority of responding to message 102. For example, response priority data 320 may indicate that responding to message 102 should be considered high priority, very high priority, low priority, medium priority, or some other priority level. In some examples, response priority data 320 may quantify a priority of responding to message 102. For example, response priority data 320 may represent a priority of responding to message 102 on a scale of 0 to 100, 100 being the highest. As described below, response priority data 320 may be used by response generator 400 to generate a response 500. In some examples, response priority data 320 can be used by human responders to determine the order of personal responses given limited response capacity; for instance, human responders may provide a personal, human-authored response to a message that corresponds to the highest priority level. Similarly, for example, at a live venue, response priority data 320 may be used to prioritize amongst competing potential customer response options.

In some examples, response priority module 310 may determine whether a response to message 102 would be undesirable by the recipient. For example, where message 102 does not expressly solicit a response (e.g., where message 102 is a general comment on a social media service), response priority module 310 may make a determination that a response to message 102 would be welcome and appropriate; or that it would likely be seen as intrusive or annoying, such that it would be preferable to send no response at all. Response priority module can make this determination based on a combination of content characteristics 220, author characteristics 240, and/or metadata characteristics 260.

In some examples, response priority data 320 may be based on one or more content characteristics 220. For example, content characteristics 220 may indicate that message 102 concerns a time-sensitive subject (e.g., a promotional offer that will expire in 24 hours). Response priority data 320 may reflect this by indicating that responding to author 100 is high priority. Response priority data 320 may further indicate that author 100 should receive a response as soon as possible, but in no event later than the expiration of the promotional offer. Similarly, content characteristics 220 may indicate that message 102 relates to a subject that does not merit a response at all (e.g., unsolicited junk email). Response priority data may reflect this by indicating that responding to author 100 is very low priority.

In some examples, response priority data 320 may be based on one or more author characteristics 240. For example, author characteristics 240 may reflect that author 100 is a particularly important or influential customer; for instance, author 100 may be a high volume customer, or may have a large number of followers on social media. Response priority data 320 may reflect this by indicating that responding to author 100 is high priority. Similarly, author characteristics 240 may indicate that author 100 is not a current customer, and belongs to a demographic that is unlikely to ever become a customer. For example, author 100 may be a male customer who is unlikely to purchase products produced exclusively for female customers. Response priority data 320 may reflect this by indicating that responding to author 100 is relatively low priority.

In some examples, response priority data 320 may be based on one or more metadata characteristics 260. For example, metadata characteristics 260 may indicate that message 102 was received within the last ten minutes. Responding to such a message may be lower priority than responding to a message that was received several days ago (and whose author has been waiting longer for a response, or has expressed concern about not yet receiving a response). Response priority data 320 can reflect this by indicating that responding to author 100 is high priority.

With respect to FIG. 3, in some examples, message analyzer 300 includes a response categorization module 330. Response categorization module 330 can accept as input one or more content characteristics 220, author characteristics 240, and/or metadata characteristics 260 relating to message 102. Response categorization module 330 can output response categorization data 340 that indicates a response category of a response to message 102. For example, in an example response center for responding to messages relating to a university, response categorization data 340 may indicate that a response should belong to a “proud parent” category; a “football fan” category; a “current student” category; or some other category. Further, response categorization data 340 may indicate that a response should belong to two or more categories. In some examples, one or more categories may correspond to a cluster of responses that may share a theme, as described above. As described below, response categorization data 340 may be used by response generator 400 to generate and/or select a response 500.

In some examples, response categorization data 340 may be based on one or more content characteristics 220. For example, in an example response center for responding to messages relating to a university, content characteristics 220 may indicate that message 102 expresses a particular sentiment regarding the university's football team. Response categorization data 340 may reflect this by indicating that response center 110 should generate a response 500 that responds appropriately to that sentiment. As another example, content characteristics 220 may indicate that message 102 is a request for information about a particular person. Response categorization data 340 may reflect this by identifying specific information that response center 110 can incorporate into generating a response 500. For example, as described herein, response generator 400 may be configured to use response categorization data 340 as input to decision logic that determines a response 500 from a plurality of possible responses. Such decision logic may, in some examples, determine that response 500 should correspond to a first possible response, rather than a second possible response, based on a decision hierarchy.

In some examples, response categorization data 340 may be based on one or more author characteristics 240. For example, in an example response center for responding to messages relating to a university, author characteristics 240 may indicate that author 100 is a parent of a current student at the university. Response categorization data 340 may reflect this by indicating that response center 110 should generate a response 500 that acknowledges that author 100 is a parent (e.g., “Hey there, proud parent!”). As another example, author characteristics 240 may indicate that author 100 is an applicant for a job at the university. Response categorization data 340 may reflect this by indicating that response center 110 should generate a response 500 that provides the author's job application status, or provides other relevant information.

In some examples, response categorization data 340 may be based on one or more metadata characteristics 260. For example, metadata characteristics 260 may indicate that author 100 previously sent a message, but did not yet receive a response. Response categorization data 340 may reflect this by indicating that response center 110 should generate a response 500 that acknowledges the author's outstanding message (e.g., “Sorry for not responding to your previous request”). As another example, metadata characteristics 260 may indicate that author 100 composed message 102 using a smartphone. Response categorization data 340 may reflect this by indicating that response center 110 should generate a response 500 that suggests that author 100 download an app for his or her smartphone. In some examples, metadata characteristics 260 could indicate that author 100 frequently communicates with response center 110; response categorization data 340 may reflect this by generating a response 500 that acknowledges the author's current and past messages.

In some examples, response categorization data 340 can take into account trends identified from multiple users. For example, if a large number of users suddenly express interest in a controversy involving a football team's head coach, response categorization data 340 can identify that response 500 may want to acknowledge the controversy. This reflects the likelihood that an author 100 is interested in trending topics identified from other users.

In the examples described herein, any suitable means may be employed to determine response categorization data 340 from content characteristics 220, author characteristics 240, and/or metadata characteristics 260. In some examples, message analyzer 300 may employ a rule-based system, or any other suitable decision logic, to determine response categorization data 340. In some examples, such decision logic may be defined in advance. For example, the decision logic may be programmed to, while in operation during football season, be especially sensitive to content characteristics 220 relating to football, and determine response categorization data 340 accordingly (e.g., by indicating at the slightest mention of football in message 102 that response 500 should include a football reference). In some examples, such decision logic may be generated and modified during operation of message analyzer 300, potentially based on response feedback data 502. For instance, if the response center 110 receives an unexpectedly high number of messages relating to football, the decision logic may be adjusted accordingly. The decision logic may also be adjusted if response feedback data 502 indicates that certain types of responses 500 are more well-received than others. In some examples, machine learning technologies (e.g., neural networks, genetic algorithms, support vector machines, Bayesian networks, learning classifier systems) may be employed to optimize the decision logic used by message analyzer 300 to determine response categorization data 340.

With respect to FIG. 3, in some examples, message analyzer 300 includes a localization module 350. Localization module 350 can accept as input one or more content characteristics 220, author characteristics 240, and/or metadata characteristics 260 relating to message 102. Localization module 350 can output localization data 360 that indicates location-specific or language-specific information relating to message 102. For example, localization data 360 may indicate that author 100 of message 102 speaks Spanish; that author 100 of message 102 lives in the United States in the New York area; or that message 102 was sent from a location corresponding to a particular set of GPS coordinates. As described below, localization data 360 may be used by response generator 400 to generate and/or select a response 500.

In some examples, localization data 360 may be based on one or more content characteristics 220. For example, content characteristics 220 may indicate that message 102 is a request for information about upcoming events in London. Localization data 360 may reflect this by indicating that author 100 may be British, and thus may expect response 500 to use spelling and grammar consistent with British English.

In some examples, localization data 360 may be based on one or more author characteristics 240. For example, author characteristics 240 may indicate (for example, based on a search of a customer database) that author 100 lives in the American South. Localization data 360 may reflect this by indicating that author 100 may be interested in localized promotional content, such as a video with stories tailored to customers from that region.

In some examples, localization data 360 may be based on one or more metadata characteristics 260. For example, metadata characteristics 260 may indicate that message 102 originated from a computer in Japan. As above, localization data 360 may reflect this by indicating that author 100 may be interested in localized promotional content tailored to customers located in that region.

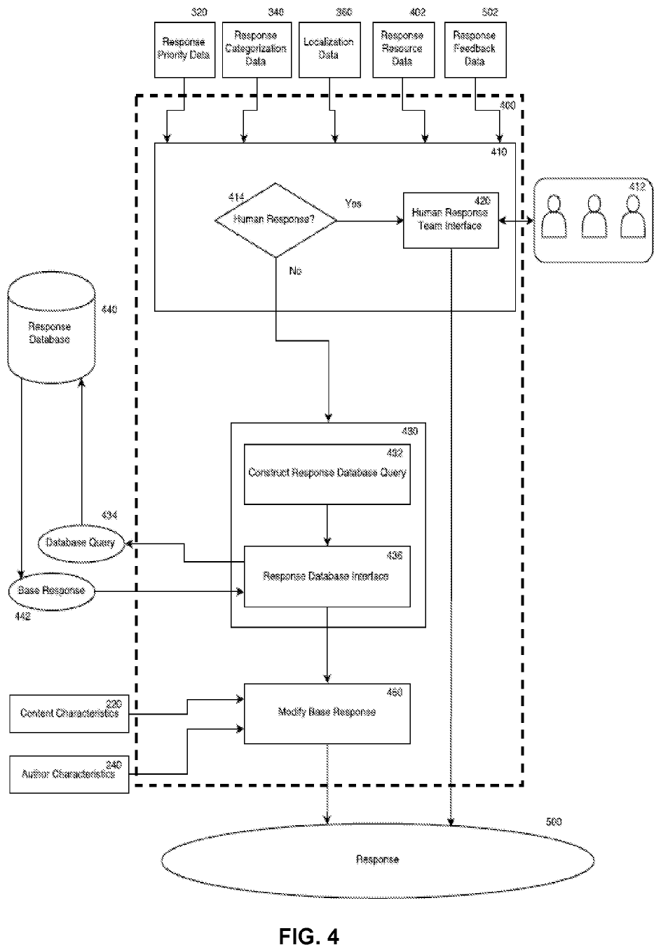

FIG. 4 illustrates an example response generator 400. In some examples, response generator 400 inputs one or more response priority data 320, response categorization data 340, and/or localization data 360 relating to message 102, and outputs one or more responses 500. In some examples, response generator 400 can additionally input response resource data 402, which may reflect resources available to generate response 500. For instance, response resource data 402 could indicate that three members of a human response team are available to generate response 500; that no members of a human response team are available; or that a member of a human response team will be available in 15 minutes. In some examples, response generator 400 can input response feedback data 502, which may include information based on an outcome of previous responses.

With respect to FIG. 4, in some examples, response generator 400 includes a response routing module 410. Response routing module 410 may identify an element of response center 110 to generate a response 500 to message 102. In some examples, that element may be a hardware or software system or module associated with response center 110. In some examples, that element may be one or more humans, such as one or more members of a human response team 412. Response routing module 410 may select an element of response center 110 to generate response 500 based on one of more of response priority data 320, response categorization data 340, localization data 360, response resource data 402, and/or response feedback data 502. In some instances, response generator 400 may determine the appropriate signor and contact information for an appropriate human response team member, for example, if follow-up is required based on response priority data 320, response categorization data 340, localization data 360, response resource data 402, and/or response feedback data 502.

In some examples, response routing module 410 may use response priority data 320 to determine whether a response 500 should be generated at all. In some examples, response routing module 410 may include one or more threshold priority values, and response priority data may quantify a response priority, for instance on a scale of 0 to 100 as described above. In some examples, if the response priority falls below a threshold priority value, response routing module 410 may determine that a response 500 should not be generated. In some examples, if the response priority falls below a threshold priority value, or falls between a range of threshold priority values, response routing module 410 may determine that response 500 should be generated, but not until higher priority messages have been responded to. In some examples, response routing module 410 may include a threshold value that varies depending on one or more inputs to response routing module 410. For example, if response resource data 402 indicates that response center 110 is receiving a very high volume of messages, a threshold priority value may be increased, to reflect that response center 110 has fewer resources to respond to messages than it would if it were receiving a lower volume of messages.

In the example shown in FIG. 4, response routing module 410 may determine at stage 414 whether response 500 should be generated by human response team 412. For example, response routing module 410 may determine at stage 414 from response resource data 402 that sufficient human resources exist for human response team 412 to generate a response 500; from response priority data 320 that the priority of responding to message 500 is high; and/or from response categorization data 340 that author 100 would prefer a human-authored response to a machine-generated response. Response routing module 410 may accordingly determine that human response team 412 should generate response 500. In some examples, in accordance with such a determination, response routing module 410 may select a human response team interface 420 to request response 500 from human response team 412, and to receive response 500 after it has been authored by human response team 412. Human response team interface 420 may then communicate response 500 to author 100 using any of a variety of communication means. For example, response 500 may be communicated to author 100 via email, text message, in-app response, social media, voice mail, or traditional mail. In some examples, response routing module 410 may provide human response team 412 with information to guide the authoring of response 500. For example, response routing module 410 may suggest responses for human response 412 to select and/or customize, or provide analytical data indicating which responses may be likely to be well-received by author 100. In some examples, response routing module 410 may identify a particular entity within human response team 412 to whom message 102 should be directed; for instance, if response priority data 320 indicates that responding to message 102 is urgent, message 102 may be escalated to a supervisor-level responder. Similarly, response routing module 410 may use response categorization data 340 to identify a particular person or department within human response team 412 that is best suited to generate response 500. As another example, response routing module may use localization data 360 to direct message 102 to a member of human response team 412 who has the necessary language skills to respond to message 102.

Conversely, response routing module 410 may determine at stage 414 from response resource data 402 that there are insufficient human resources for human response team 412 to generate a response 500 (for example, based on volumes or hours of availability); from response priority data 320 that the priority of responding to message 500 is low; and/or from response categorization data 340 that author 100 would not prefer a human-authored response to a machine-generated response. Response routing module 410 may accordingly determine that human response team 412 should not generate response 500, and that a computer-generated response is the best available alternative.

In some examples, in accordance with a determination that human response team 412 should not generate response 500, or in the absence of a determination that human response team 412 should generate response 500, response routing module 410 may identify that response selector 430 should select either a response 500, or a base response from which response 500 can be generated.

With reference to FIG. 4, in some examples, response selector 430 may interface with a response database 440 that can provide one or more base responses 442 from which response 500 can be generated. In some examples, response selector 430 can, at stage 432, construct a database query 434 to be presented to response database 440. Database query 434 can be constructed at stage 432 using one or more of response priority data 320, response categorization data 340, localization data 360, and/or response feedback data 502. Database query 434 can be configured to obtain a base response 442 from response database 440 that can be used to generate a response 500 that will satisfy author 100 of message 102, or otherwise respond appropriately to message 102. In some examples, database query 434 can include one or more parameters designed to procure a particular type of base response 442 from response database 440. For example, if response categorization data 340 indicates that response 500 should include a reference to author 100 being a current customer, database query 434 could include a parameter instructing response database 440 to retrieve a base response 442 that includes such a reference. As another example, if localization data 360 indicates that response 500 should be tailored for native Chinese speakers, database query 434 could include a parameter instructing response database 440 to retrieve a base response 442 that is written in Chinese, or in some examples, can be translated to Chinese. As another example, if response categorization data 340 indicates that response 500 should include a promotional offer, and localization data 360 indicates that author 100 lives in Canada, database query 434 could include a parameter instructing response database 440 to retrieve a base response 442 that includes a promotional offer applicable to Canadian residents. Database query 434 may otherwise reflect one or more of response priority data 320, response categorization data 340, localization data 360, and response feedback data 502.

In some examples, if response categorization data 340 indicates that response 500 should include a video, database query 434 could include a parameter instructing response database 440 to retrieve a base response 442 that includes a video, or in some examples, a link to an online video. For example, if an employee is watching a training video, such employee may receive a response center feedback prompt embedded in, or adjacent to, the video. An example prompt may ask if the employee understood the subject matter or related areas, and response 500 may accordingly link to an explanatory video during the viewing session.

In some examples, response database interface 436 can communicate database query 434 to response database 440. Response database 440 may be a relational database, a hierarchical database, or any other suitable type of database. Further, response database 440 may store base responses, such as response 442, in any suitable data format. Response database 440 can be configured to receive database query 434 and, in response to receiving database query 434, identify a base response 442 in accordance with one or more parameters or aspects of database query 434. For example, if database query 434 includes a parameter specifying a video response; a parameter specifying a response expressing the sentiment “thank you”; a parameter specifying a response mentioning a particular football team; and a parameter specifying a response written in Spanish; response database 440 can identify a base response 442 that is written in Spanish, expresses the sentiment “thank you,” mentions the football team, and includes a link to a tailored video. In some examples, response database 440 may construct base response 442 in response to receiving a particular database query 434. Base response 442 may belong to any suitable response format. For example, base response 442 can include text (e.g., for insertion into an email, a social media post, or a text message); audio (e.g., for communication via telephone or streaming audio); video or audio/video (e.g., for uploading to an online video service, such as YouTube); or one or more images (e.g., emojis). In some examples, base response 442 may correspond to a link to online content. Response database 440 may communicate base response 442 to response selector 430, for example via response database interface 436.

In some examples, base response 442 may be provided to author 100 as response 500, and may be communicated via any suitable means (e.g., email, social media, text message, voice mail, online video, client message portal, mobile app).

In some examples, base response 442 may be modified at stage 450 to specifically address author 100 and/or aspects of message 102. For example, base response 442 may include a “name” variable that can be replaced with the name of author 100. At stage 450, response generator 400 could identify the name of author 100, for example via author characteristics 240, and replace the “name” variable of base response 442 with the name of author 100. As another example, if base response 442 relates to a product, base response 442 might include a “product name” variable that can be replaced with the name of a product mentioned in message 102. At stage 450, response generator 400 could identify the name of the product, for example via content characteristics 220, and replace the “product name” variable of base response 442 with the name of the product. In some examples, such product name could be adjusted based on geography.

After modifying base response 442, for example as described above, response generator 400 can provide a modified base response to author 100 as response 500. Response 500 may be communicated via any suitable means (e.g., email, social media, text message, voice mail, online video, client message portal, mobile app). Response 500 may, but need not, be communicated using the same means by which message 102 is communicated. For example, message 102 may be received via an app, while response 500 to message 102 may be provided by text.

In some examples, response 500 may incorporate statistical data, or other data generated or determined by response center 110. For instance, if message 102 was one of over ten thousand messages received by response center 110 on a particular subject, response 500 may acknowledge that fact. In some examples, this statistical data can include or be based on social media analytics (e.g., which topics are trending on a particular social media platform).

In some examples, response 500 may incorporate information known about author 100, including previous messages received from author 100. As an example, if message 102 reflects a change in the author's opinion about a subject compared with a previous message from author 100, response 500 may reference that change in opinion (e.g., “We are happy to see your opinion is more positive than it was last year”). As another example, if relevant information is available regarding author 100 (for example, via a customer database), response 500 may reference that information, instead of or in addition to other information in response 500 (e.g., by including “Congratulations on five years as a loyal gold card member” in response 500).

In some examples (not shown), response center 110 may include a response scheduling module for scheduling an appropriate time to send response 500 to author 100. For example, if message 102 relates to a football team, the response scheduling module can schedule response 500 to be sent on the first day of the football season. In some examples, the response schedule module may utilize response priority data 320 to determine an appropriate time to send response 500. For example, if response priority data 320 indicates that responding to message 102 is high priority, the response scheduling module can schedule response 500 to be sent right away.

In some examples, response center 110 may track responses, such as response 500, and identify effects of those responses, for example on authors such as author 100. For example, response center 110 may track whether a particular response resulted in greater customer retention, positive word-of-mouth, or other results. Information resulting from tracking these responses can be reflected in response feedback data 502, and used to generate various data used by response center 110, as described above. For example, response feedback data 502 could inform the generation of response priority data 320 and/or response categorization data 340, or the construction of database query 434 at stage 432.

In some examples, as described above, message 102 may be communicated by author 100 to response center 110 using interactive elements embedded in, or associated with, a first video. Such interactive elements may include survey prompts, web links, online forms, user interface widgets, emojis, or other suitable elements. In some examples, as described above, response center 110 may communicate a response 500 to message 102 in a format that includes information for a second video. In some such examples, the second video may be presented to author 100 immediately in response to receiving message 102. For instance, if message 102 indicates that the subject matter of the first video is too advanced for author 100, response 500 may include a second video that presents the subject matter at a lower level of difficulty. Further, in some examples, the second video may include interactive elements that may be used to generate a second message from author 100 to response center 110. In this manner, the response center 110 can provide a sequence of real-time video responses to the information conveyed (via interactive elements associated with the video) by author 100.

In some examples, response 500 may be communicated to multiple recipients, such as a group of authors 100 who expressed interest in the same topic. Response 500 may also be communicated to all members of an organization, such as a social media group, or to some subset of that organization (e.g., only those members of a social media group who expressed interest in football tickets). In some examples, response 500 may be communicated privately to the recipient (e.g., via email); but in some examples, response 500 may be communicated publicly (e.g., via a public reply to a comment on a social media platform).

In some examples, response 500 may be presented as originating from a particular source. For example, if response 500 relates to a university's football team, response 500 may be an email sent from an email address belonging to the university's athletic director; but if response 500 relates to a university's new biology lab, response 500 may be sent from an email address belonging to the head of the university's biology department. Similarly, if response 500 addresses a serious matter, it may be shown as originating from a more authoritative source (e.g., the president of a university) than if response 500 addresses a more casual matter. In some examples, the apparent source of response 500 may be determined based on one or more of content characteristics 220, author characteristics 240, and/or metadata characteristics 260, as described above.

The examples described above may operate on one or more computers (e.g., one or more servers), including non-transitory computer readable recording media on a computer. This readable media contains the program instructions for accomplishing various steps described above. In the context of this document, a computer-readable recording medium can be any medium that can contain or store programming for use by or in connection with an instruction execution system, apparatus, or device. Such computer readable media may be stored on a memory, where a memory is any device capable of storing a computer readable medium and capable of being accessed by a computer. A memory may include additional features. A computer may include a processor. A processor can be any device suitable to access a memory and execute a program stored thereon.

Communications may be transmitted between nodes over a communications network, such as the Internet. Other communications technology may include, but is not limited to, any combination of wired or wireless digital or analog communications channels, such as instant messaging (IM), short message service (SMS), multimedia messaging service (MMS) or a phone system (e.g., cellular, landline, or IP-based). These communications technologies can include Wi-Fi, BLUETOOTH and other wireless radio technologies.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

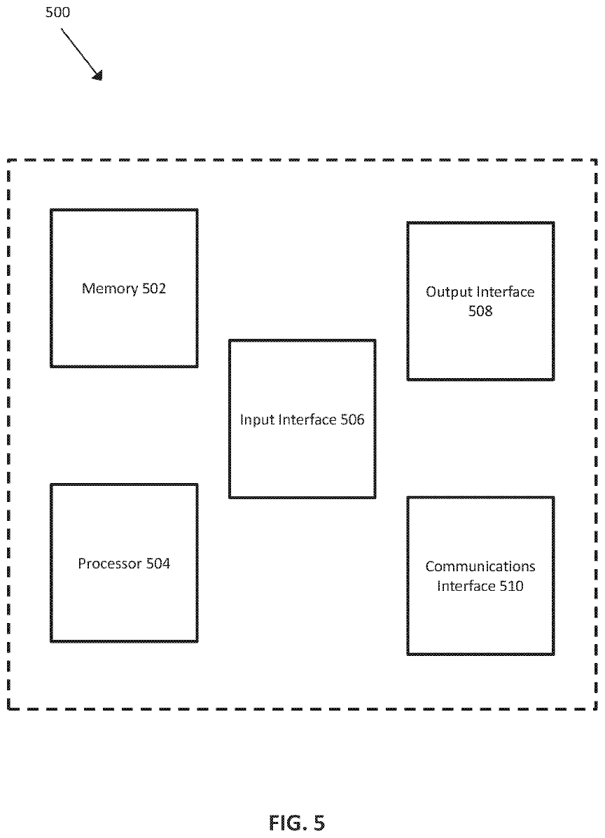

FIG. 5 illustrates an example computer 500 capable of implementing the disclosed examples. Example computer 500 includes a memory 502, a processor 504, an input interface 506, an output interface 508, and a communications interface 510.

Memory 502 may include volatile and non-volatile storage. For example, memory storage may include read only memory (ROM) in a hard disk device (HDD), random access memory (RAM), flash memory, and the like. The Operating System (OS) and application programs may be stored in ROM.

Specific software modules that implement embodiments of the described systems and methods may be incorporated in application programs on a server. The software may execute under control of an OS.

Processor 504 may include any device suitable to access a memory and execute a program stored thereon.

Input interface 506 may include a keyboard or mouse, for example. Output interface 508 may include a conventional color monitor and printer, such as a conventional laser printer. Output interface 508 may provide requisite circuitry to electrically connect and interface the display and printer to the computer system.

Communications interface 510 may allow the network and nodes to connect directly, or over another network, to other nodes or networks. The network can include, for example, a local area network (LAN), a wide area network (WAN), or the Internet. In some embodiments, the network, modules, and nodes can be connected to another client, server, or device via a wireless interface.

In some embodiments the input interface, processor, memory, communications interface, output interface, or combinations thereof, are interconnected by a bus.

The disclosed embodiments could be embodied as a JAVA tool, which means it can run on any platform that is JAVA enabled. Embodiments can run on a web server that provides a website for administrators to monitor the system results remotely. Anyone with administrative access to the web server can connect to and use visualization tools to take actions within a visualization. The embodiments can run on any type of server, including virtual servers or an actual machine. While JAVA is provided as an example, any suitable programming language or technology can be used to implement the examples of the disclosure.

The disclosed examples may be embodied on a distributed processing system to break processing apart into smaller jobs that can be executed by different processors in parallel. The results of the parallel processing could then be combined once completed.

Although the present invention has been fully described in connection with examples thereof with reference to the accompanying drawings, it is to be noted that various changes and modifications will become apparent to those skilled in the art. Such changes and modifications are to be understood as being included within the scope of the claimed subject matter. The various examples of the invention should be understood that they have been presented by way of example only, and not by way of limitation. Although the invention is described above in terms of various examples and implementations, it should be understood that the various features and functionality described in one or more of the individual examples are not limited in their applicability to the particular example with which they are described. They instead can, be applied, alone or in some combination, to one or more of the other examples of the invention, whether or not such examples are described, and whether or not such features are presented as being a part of a described example. Thus the breadth and scope of the claimed subject matter should not be limited by any of the above-described examples.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described examples of the invention with reference to different functional units and modules. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

In the foregoing description of examples, reference is made to the accompanying drawings which form a part hereof, and in which it is shown by way of illustration specific examples in which the invention may be practiced. It is to be understood that other examples may be utilized and structural changes may be made without departing from the scope of the claimed subject matter.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the claimed subject matter.

What is claimed is:

1. A method of communicating a response, the method comprising:
receiving, at a response center, a message having at least one of a content characteristic and a metadata characteristic, the message associated with an author having an author characteristic;
determining a response categorization data based on at least one of the content characteristic, the metadata characteristic, and the author characteristic;
determining a first response, the first response associated with the response categorization data; and
communicating the first response to the author.

2. The method of claim 1, further comprising determining a localization data based on at least one of the content characteristic, the metadata characteristic, and the author characteristic, wherein the first response is further associated with the localization data.

3. The method of claim 1, further comprising determining a video associated with at least one of the content characteristic, the metadata characteristic, and the author characteristic, wherein the first response comprises the video.

4. The method of claim 1, wherein determining a first response comprises determining, based on one or more of the content characteristic, the metadata characteristic, and the author characteristic, whether the first response should be a human-authored response, the method further comprising:
in accordance with a determination that the first response should be a human-authored response, generating a human-authored response, and
in accordance with a determination that the first response should not be a human-generated response, generating a computer-generated response.

5. The method of claim 1, further comprising determining the author characteristic based on the at least one of a content characteristic and a metadata characteristic.

6. The method of claim 1, further comprising:
presenting a prompt to the author, the survey comprising a plurality of invitations to provide input; and
determining the author characteristic based on a response of the author to the prompt.

7. The method of claim 6, wherein the response of the author to the prompt comprises a failure of the author to respond to one of the plurality of invitations to provide input, and wherein the author characteristic is determined based on the failure to respond to one of the plurality of invitations to provide input.

8. The method of claim 1, further comprising determining the author characteristic based on first information from a first source having a first media type and second information from a second source having a second media type different from the first media type.

9. The method of claim 1, wherein the author is a social media group, and communicating the first response to the author comprises communicating the response to a subset of the social media group.

10. The method of claim 1, wherein the message is received at the response center via a social media platform, and wherein the message does not solicit the first response.

11. The method of claim 1, wherein the author characteristic is an author profile comprising a plurality of characteristics of the author.

12. A system comprising:
one or more processors;
memory storing instructions, which when executed by the one or more processors, cause the one or more processors to perform a method comprising:
receiving, at a response center, a message having at least one of a content characteristic and a metadata characteristic, the message associated with an author having an author characteristic;
determining a response categorization data based on at least one of the content characteristic, the metadata characteristic, and the author characteristic;
determining a first response, the first response associated with the response categorization data; and
communicating the first response to the author.

13. The system of claim 12, wherein the method further comprises:
presenting a prompt to the author, the prompt comprising a plurality of invitations to provide input, and determining the author characteristic based on a response of the author to the prompt, wherein:
the response of the author to the prompt comprises a failure of the author to respond to one of the plurality of invitations to provide input, and
the author characteristic is determined based on the failure to respond to one of the plurality of invitations to provide input.

14. The system of claim 12, wherein the method further comprises determining the author characteristic based on first information from a first source having a first media type and second information from a second source having a second media type different from the first media type.

15. The system of claim 12, wherein the message is received at the response center via a social media platform, and wherein the message does not solicit the response.

16. A non-transitory computer-readable medium storing instructions that, when executed by one or more processors of a computer system, cause the one or more processors to perform a method comprising:
receiving, at a response center, a message having at least one of a content characteristic and a metadata characteristic, the message associated with an author having an author characteristic;
determining a response categorization data based on at least one of the content characteristic, the metadata characteristic, and the author characteristic;
determining a first response, the first response associated with the response categorization data; and
communicating the first response to the author.

17. The non-transitory computer-readable medium of claim 16, wherein the method further comprises:
presenting a prompt to the author, the prompt comprising a plurality of invitations to provide input, and determining the author characteristic based on a response of the author to the prompt, wherein:
the response of the author to the prompt comprises a failure of the author to respond to one of the plurality of invitations to provide input, and
the author characteristic is determined based on the failure to respond to one of the plurality of invitations to provide input.

18. The non-transitory computer-readable medium of claim 16, wherein the method further comprises determining the author characteristic based on first information from a first source having a first media type and second information from a second source having a second media type different from the first media type.

19. The non-transitory computer-readable medium of claim 16, wherein the message is received at the response center via a social media platform, and wherein the message does not solicit the response.

20. The non-transitory computer-readable medium of claim 16, wherein the author is a social media group, and communicating the first response to the author comprises communicating the response to a subset of the social media group.
